(19) United States
(12) Patent Application Publication
(10) Pub. No.: US 2016/0174657 A1
(43) Pub. Date: Jun. 23, 2016

(54) Dynamically Controlling Air-Chamber Footwear

(71) Applicant: Brady A. Fox-Mudge, San Luis Obispo, CA (US)

(72) Inventor: Brady A. Fox-Mudge, San Luis Obispo, CA (US)

(21) Appl. No.: 14/863,242

(22) Filed: Sep. 23, 2015

Related U.S. Application Data
(60) Provisional application No. 62/086,812, filed on Dec. 3, 2014.

(51) Int. Cl. A43B 13/20; A43B 13/18; A61H 9/00; A43B 3/00

(52) U.S. Cl. CPC A43B 13/203; A43B 3/0005; A43B 13/182; A43B 13/183; A43B 13/187; A61H 9/005

(57) ABSTRACT

In some implementations, a shoe includes a sole, a plurality of air chambers, an air pump, and one or more processors. The sole may encloses the plurality of chambers configured to expand and contract based on air pressure, and portions of the sole define air channels. The first end of each of the plurality of air channels is connected to a respective one of the plurality of chambers. The air pump connects to a second end of each of the plurality of air channels and is configured to pump air through the plurality of chambers. The one or more processors communicably couple to the air pump and are configured to, in response to an event, transmit a signal to the air pump to pump air through the plurality of air channels.

### TECHNICAL FIELD

This invention relates to footwear, and more particularly to dynamically controlled air-chamber footwear.

### BACKGROUND

The human foot is an intricate formation comprising twenty six bones, and thirty three joints, and over one hundred muscles, tendons, and ligaments. The foot is the main interface between the human body and the earth, and requires protection and comfort. The first shoes were worn over ten thousand years ago, and were sandals made from animal skins. As civilizations developed, so did footwear.

### SUMMARY

In some implementations, a shoe includes a sole, a plurality of air chambers, an air pump, and one or more processors. The sole may encloses the plurality of chambers configured to expand and contract based on air pressure, and portions of the sole define air channels. The first end of each of the plurality of air channels is connected to a respective one of the plurality of chambers. The air pump connects to a second end of each of the plurality of air channels and is configured to pump air through the plurality of chambers. The one or more processors communicably couple to the air pump and are configured to, in response to an event, transmit a signal to the air pump to pump air through the plurality of air channels.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of the system of the present invention.

FIG. 2 is a plain side view of the system of the present invention.

FIG. 3 is a plain bottom view of the system of the present invention.

FIG. 4 demonstrates the location of the detail view of FIG. 5

FIG. 5 is a detail view showing the microprocessor and pressurized lace.

FIG. 6 is a bottom view of the system of the present invention demonstrating the location of the detail view of FIG. 7.

FIG. 7 is a detail view of the pump, plurality of chambers, and lace channels.

FIG. 8 is a system including an example air chamber located within a sole.

FIG. 9 is a flow chart illustrating an example method for managing air pressure in air chambers in a sole of a shoe.

Like reference symbols in the various drawings indicate like elements.

### DETAILED DESCRIPTION

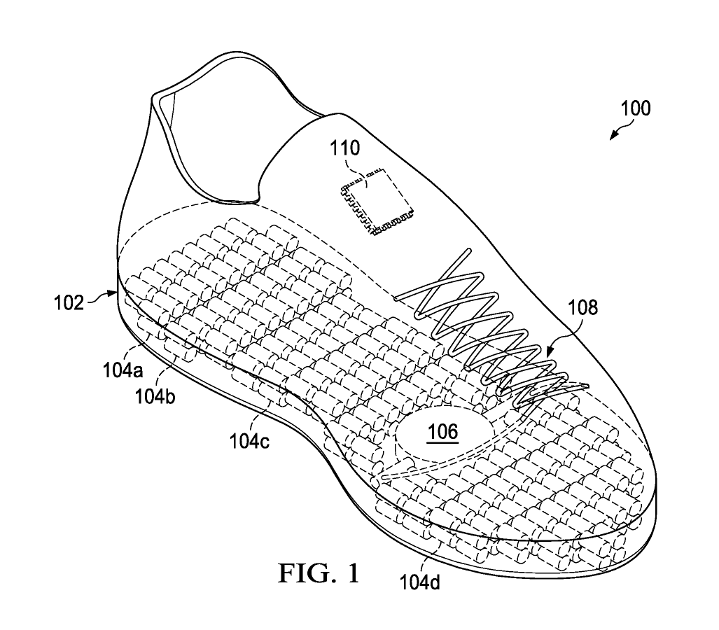

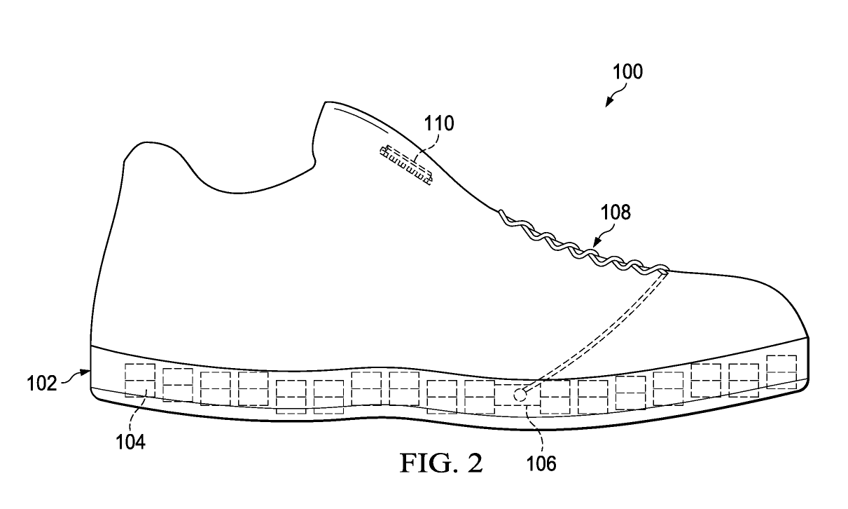

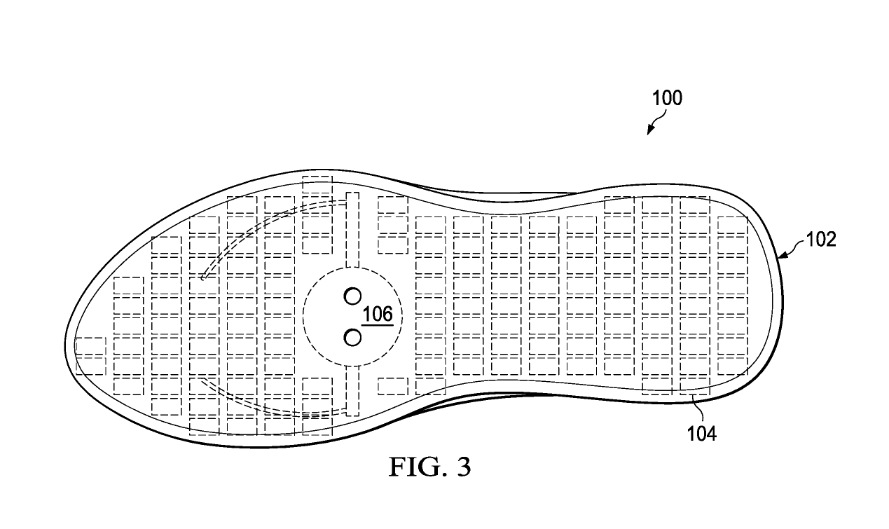

FIGS. 1-5 illustrate different views of a shoe 100 including air chambers. For example, the shoe 100 may be an athletic shoe that includes a flexible sole that encloses a plurality of air chambers that dynamically adjust air within each chamber in response to user activity (e.g., running versus walking). The shoe 100 may be other types of shoes without departing from the scope of this disclosure such as a work boot, an orthopedic shoe, a dress shoe, or others. As illustrated, the shoe 100 includes a sole 102 that encloses or otherwise includes a plurality of air chambers 104, an air pump 106 that pumps air in and out of the plurality of air chambers 104, air laces 108, and a microprocessor 110 that controls the air chambers 104, the air pump 106, and associated valves. In some implementations, the microprocessor 110 adjust the air in the plurality of air chambers 104 to provide, for example, cushion to the wearer's feet, support, comfort, compensation for an uneven gate, or other advantages.

The sole 102 can be any material including portions defining cavities for the plurality of air chambers 104. For example, sole 102 may be a natural leather, a synthetic leather, nylon, rubber, synthetic fabrics, other materials, or a combination thereof. In some implementations, the sole 102 may include a base that includes portions defining cavities and a flexible layer affixed to the top of the base that responds to the plurality of air chambers 104 in the base. In some implementations, the cavities are substantially cylindrical with an axis substantially parallel to a top surface of the sole 102. In some implementations, the axis may be perpendicular to the top surface of the sole 102. The cavities may include other shapes or combinations thereof without departing from the scope of the disclosure. In addition to the cavities, portions of the sole 102 may form air channels that connect the plurality of air chambers 104 to the air pump 106. In other words, the plurality of air channels may be conduits through which air flows. The air channels may route air from the air pump 106 to the chambers 104, or between chambers 104.

As illustrated, the air chambers 104 are located within the sole 102 of the shoe 100. In some implementations, the air chambers 104 may be arranged in rows and/or layers. For example, the chambers 104 may arranged serially in multiple rows as well as columns. In some implementations, the total number of chambers 104 in the sole 102 may be thirty to forty chambers in two or more layers. However, the total number of chambers 104 in the sole 102 include more or less chambers 104 in a single or multiple rows without departing from the scope of the disclosure. In instances when the cavities are cylindrical, the chambers 104 may be cylindrical in shape. In some implementations, the chambers 104 may be include shapes substantially similar to the cavities, different from the shapes of the cavities, or a combination thereof. In some implementations, the air chambers 104 may include an outer metal layer with an inner flexible layer (e.g., rubber).

In some implementations, the chambers 104 can include an elastic element, a chamber pressure sensor, and a chamber valve. The elastic element may generate an initial positive pressure state rather than relying solely on air pressure to support the wearer's weight while in a neutral state. In these instances, the elastic element may include at least one of a flyleaf spring, helical spring, flexible truss-like structure, porous, springy material, or other support material. The chamber pressure sensors are configured to detect pressure within respective chambers and/or between adjacent chambers either continuously, at intervals, and/or in response to a request or event. Once detect, the chamber pressure sensors may send a notification to the microprocessor 110 including information identifying the detected pressure. The chamber pressure sensor may be at least one a force collector pressure transducer (e.g., a piezoelectric pressure sensor), a digital barometric pressure sensor, a capacitive pressure sensor, an electromagnetic pressure sensor, an optical pressure sensor, a potentiometric pressure sensor, other sensor, or a combination thereof. In some implementations, the chambers may each include a plurality of pressure sensors. Each chamber valve regulates air flow into and out of a respective chamber 104. The chamber valve may be located at a junction between the chamber 104 and an associated air channel connected to that chamber 104. In some instances, the chamber valve may be a solenoid valve which receives electrical signals from the microprocessor 110 that adjust the value opening. The chamber valve may be a normally open or normally closed two-way valve. The chamber valve may further comprise gaskets, seals, or other elements without departing from the scope of the disclosure.

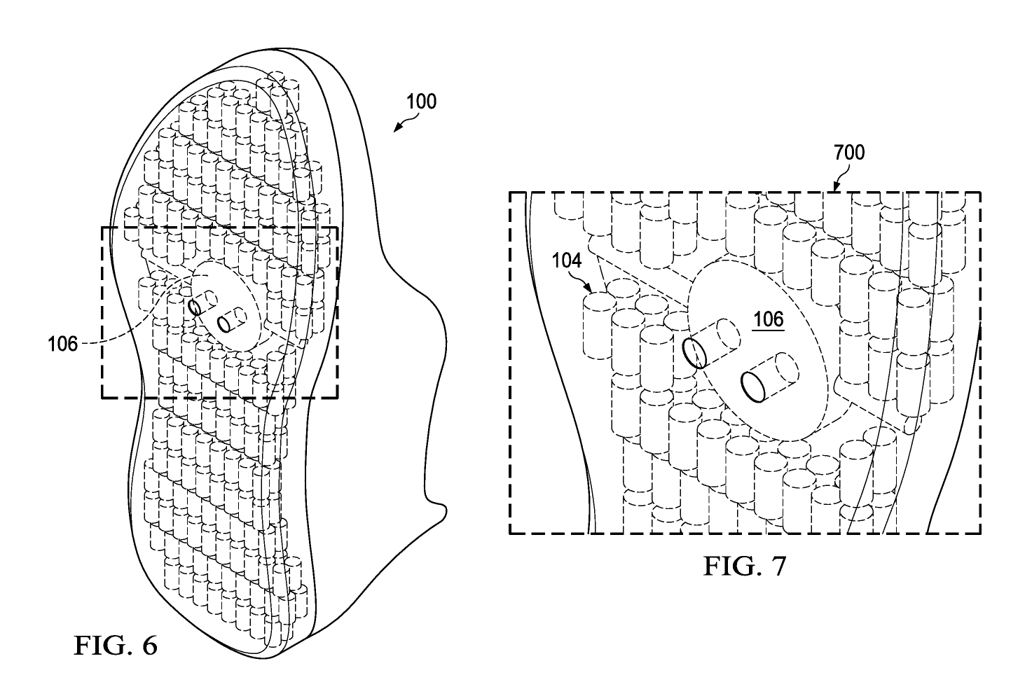

The pump 106 is configured to draws air into the system and may initiate flow into or out of the chambers 104 and/or pressurized laces 108. In some implementations, the pump may be located in the sole 102 of the shoe 1001 underneath, for example, the heel or ball of the wearer's foot. For example, FIGS. 6 and 7 illustrate the pump 106 under the ball of the foot. In some implementations, the pump 106 may be located within other parts of the shoe 100 without departing from the scope of the disclosure. In some implementations, the pump 106 may include an outer metal layer with an inner flexible layer (e.g., rubber). In some implementations, the intake for the pump may be located on a top surface of the shoe 100 to prevent the intake of liquid (e.g., water in a puddle) or solids.

In some implementations, the pump 106 may include a neoprene covering configured to use the motion of the user's foot and weight to actuate the operation of the pump 106. For example, the pump 106 may be a diaphragm pump. In this instance, the pump 106 may include a diaphragm, a pump pressure sensor, and a pump valve assembly, which permits air to flow into or out of the pump 106 to or from the chambers 104, the pressurized laces, and/or the exterior of the shoe 100. The pump pressure sensor detects pressure readings continuously, at intervals, and/or in response to a request or an event, and may send a notification to the microprocessor 110 including information identifying the detected pressure. The pump pressure sensor may be at least one of a force collector pressure transducer such as a piezoelectric pressure sensor, a digital barometric pressure sensor, a capacitive pressure sensor, an electromagnetic pressure sensor, an optical pressure sensor, a potentiometric pressure sensor, other sensor, or a combination thereof. In some implementations the pump pressure sensor may be a micro electromechanical pressure sensor. The valves of the pump valve assembly may be solenoid valves that are adjusted in response to signals from the microprocessor 110. In some implementations, the pump valve assembly may be at least one of an air intake valve, an air excretion valve, a chamber supply valve, a lace supply valve, an external valve, or other value. The air intake valve may capture ambient air from around the shoe and pump the air into the air channels. The air excretion valve may emit air from the shoe 100. The chamber supply valve may allow air to flow into and out of the pump 106 into the chambers 104. The lace supply valve allows air to flow to and from the pressurized lace 108. The external valve may enable the wearer to fill the system with air from a compressed air source. In some implementations, the pump valve assembly may include a pneumatic manifold which receives signals from the microprocessor to route airflow into and out of the chambers, the pressurized laces, and the exterior of the shoe. The pump valve assembly may further comprise gaskets, seals, and/or other elements.

In some implementations, the shoe 100 includes one or more pressurized laces 108 that act as shoe laces to tie the shoe 100 and may be filled with air. The pressurized lace 108 may include a bladder, one or more lace pressure sensors, and a valve. The bladder may a hermetically sealed conduit which runs through the length of the lace, and may be filled with air. The bladder may be connected to the air channel associated with the pressurized lace 108 and the pump 106. The one or more lace pressure sensors may be located within the bladder. Each pressure sensor detects pressure readings continuously, at intervals, or in response to an event or request, and sends a notification to the microprocessor 110 including information identifying the detected pressure. Each lace pressure sensor may be at least one of a force collector pressure transducer such as a piezoelectric pressure sensor, a digital barometric pressure sensor, a capacitive pressure sensor, an electromagnetic pressure sensor, an optical pressure sensor, a potentiometric pressure sensor, or other pressure sensors. In some implementations, the pressure sensor is one or more micro electromechanical pressure sensors. The lace valve may regulate air flow into and out of the pressurized lace 108. The lace valve may located at the junction between the pressurized lace and an associated air channel. In some implementations, the lace valve may be a solenoid valve which receives signals from the microprocessor 110 to adjust the value opening. The lace valve may be a normally open or normally closed two-way valve. The lace valve may further comprise gaskets, seals, and/or other elements.

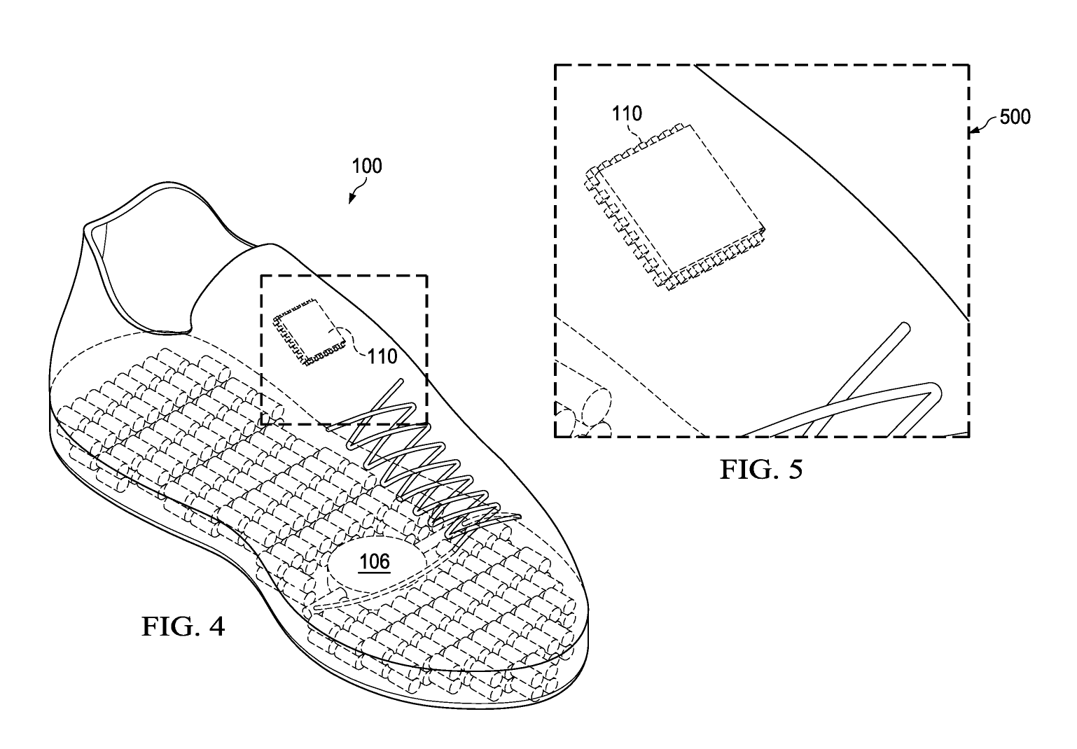

The microprocessor 110 can be any software, hardware, firmware, or configuration thereof configured to monitor pressure in the air chambers 104 and the pressurized lace 108 and transmit signals to the pump 106 to adjust the air pressure with the air chambers 104 and the pressurized lace 108. For example, the microprocessor 110 may determine that the air pressure within the air chambers 104 is too low or too high for a concurrent activity and transmit a signal to the pump 106 to adjust the air pressure. The microprocessor 110 may adjust air pressure to compensate for one or more of the following: type of flooring or surface; medical correction (e.g., difference in leg length, limp); size of foot; user weight; balance exercises; foot temperature (e.g., to cool foot), or others. In summary, the microprocessor 110 adjust the air pressure in the air chambers 104 in response to one or more events. Events may include expiration of a time period, time of day, current activity level, or others. In implementations where the chambers 104 include a valve, the microprocessor 110 may transmit signals to the values to open, close, or partially open or close the valve. In this instances, the microprocessor 110 may adjust the air pressure in different air chambers 104 to have different air pressure. FIGS. 4 and 5 illustrate the microprocessor 110 in the tongue of the shoe 100, but the microprocessor 110 may be located in other parts of the shoe without departing from the scope of the disclosure. In some implementations, the microprocessor 110 is sealed in a waterproof compartment.

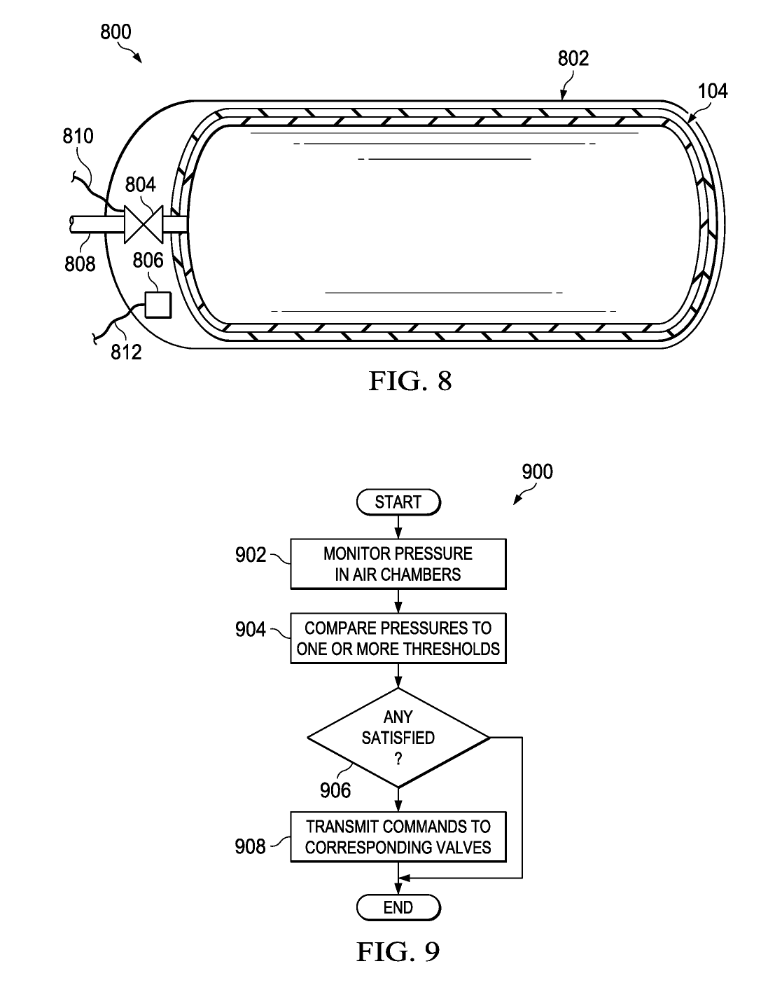

FIG. 8 is a system 100 illustrating an example air chamber 104. As illustrated, the air chamber 104 is located within a cavity 802 formed form a portion of a sole. The air chamber 104 include a passage connected to the valve 804, which, in turn, is connected to the air channel 808. As previously mentioned, the air channel 808 can formed from portions of a sole. The valve 804 is connected to the wire 810 which is used to communicate with a microprocessor. The system 800 also includes a pressure sensor 806 connected to a microprocessor through the wire 812.

FIG. 9 illustrates a flow chart illustrates an example method 900 for managing air pressure in air chambers in a sole of a shoe. The method 900 starts at step 902 where the pressure in the air chambers are monitored. For example, pressure sensors for each of the air chambers may detect air pressure and transmit the air pressure to a microprocessor. The sensors may transmit the air pressure in response to a request, periodically, detection of movement (e.g., fluctuation in air pressure), or other events. At step 904, the pressures are compared to one or more thresholds. In some implementations, the pressures associated with different areas of the sole may be compared to different thresholds. For example, the pressures associated with the ball of the foot may be compared with a threshold different from the pressures associated with the heel of the foot. If any of the thresholds is satisfied, then, at step 908, commands are transmitted to valves for the corresponding air chambers to adjust the pressure.

A number of embodiments of the invention have been described. Nevertheless, it will be understood that various modifications may be made without departing from the spirit and scope of the invention. Accordingly, other embodiments are within the scope of the following claims.

What is claimed is:

1. A shoe, comprising:
a sole enclosing a plurality of chambers configured to expand and contract based on air pressure, wherein portions of the sole define air channels, and a first end of each of the plurality of air channels is connected to a respective one of the plurality of chambers;
an air pump connected to a second end of each of the plurality of air channels and configured to pump air through the plurality of chambers; and
one or more processors communicably coupled to the air pump and configured to, in response to an event, transmit a signal to the air pump to air through the plurality of air channels.

2. The shoe of claim 1, wherein each of the plurality of chambers comprises:
an elastic member positioned in the chamber and configured to provide an initial positive pressure to that chamber;
a chamber pressure sensor communicably coupled to the one or more processors and configured to detect a pressure in that chamber and communicate the pressure to the one or more processors; and
a chamber value communicably coupled to the one or more processors and configured to open or close in response to instructions from the one or more processors.

3. The shoe of claim 2, wherein the elastic member comprises at least one of a flyleaf spring, a helical spring, a flexible truss-like structure, a porous, springy material, or another air chamber.

4. The shoe of claim 2, wherein the chamber sensor comprises at least one of a piezoelectric pressure sensor, a digital barometric pressure sensor, a capacitive pressure sensor, an electromagnetic pressure sensor, an optical pressure sensor, or a potentiometric pressure sensor.

5. The shoe of claim 2, wherein the chamber valve comprises a solenoid valve.

6. The shoe of claim 2, further comprises a pressurized lace fluidically coupled to the air pump and configured to expand and contract based on air pressure and release into the shoe.

7. The shoe of claim 6, wherein the pressurized lace comprises:
a bladder;
a lace pressure sensor communicably coupled to the one or more processors and configured to detect a pressure in the pressurized lace and communicate the pressure to the one or more processors; and
a value coupled to the one or more processors and configured to open or close in response to instructions from the one or more processors.

8. The shoe of claim 1, wherein the air pump comprises:
a diaphragm;
a pump pressure sensor communicably coupled to the one or more processors and configured to detect a pressure in the pump and communicate the pressure to the one or more processors; and
a pump value coupled to the one or more processors and configured to open or close in response to instructions from the one or more processors.

9. The shoe of claim 8, wherein the pump value comprises at least one of an air intake valve, an air excretion valve, a chamber supply valve, a lace supply valve, or an external valve.

10. The shoe of claim 1, further comprises a reservoir of air enclosed in the sole and fluidically coupled to the air diagram.

11. The shoe of claim 1, further comprises a wireless transceiver configured to wireless communicate with external devices.

12. The shoe of claim 1, wherein the event comprises a time of day, a spike in pressure, an area of the sole.

13. The shoe of claim 1, wherein the one or more processors are configured to open and close the plurality of chambers in a specified pattern.

14. The shoe of claim 13, wherein the specified pattern produces a cyclical massaging pattern.
